(19) United States
(12) Patent Application Publication
(10) Pub. No.: US 2015/0235798 A1
(43) Pub. Date: Aug. 20, 2015

(54) FUSE

(71) Applicant: YAZAKI CORPORATION, Tokyo (JP)

(72) Inventors: Naoki TAKAMURA, Susono-shi (JP); Masashi IWATA, Susono-shi (JP)

(73) Assignee: YAZAKI CORPORATION, Tokyo (JP)

(21) Appl. No.: 14/625,937

(22) Filed: Feb. 19, 2015

(30) Foreign Application Priority Data
Feb. 20, 2014 (JP) 2014-030840

(51) Int. Cl. H01H 85/08

(52) U.S. Cl. CPC H01H 85/08

(57) ABSTRACT

A fuse includes a pair of terminals and a fusible part that is provided between the pair of terminals, makes conductive connection between both of the pair of terminals, and is fused when an overcurrent flows. At least the fusible part is manufactured by a stereoscopic modeling method.

### CROSS REFERENCE TO RELATED APPLICATION

This application is based on Japanese Patent Application (No. 2014-030840) filed on Feb. 20, 2014, the contents of which are incorporated herein by reference. Also, all the references cited herein are incorporated as a whole.

### BACKGROUND OF THE INVENTION

1. Technical Field

One or more embodiments of the present invention relate to a fuse that cuts off energization by being fused when an overcurrent flows.

2. Background Art

FIG. 6 is a plan view showing a configuration of a linked fuse (also called a fusible link) described in JP-A-2008-226743. A fuse 101 shown in this FIG. 6 includes an input terminal 102 and an output terminal 103 conductively connected through an individual fusible part 110. The fusible part 110 is a portion which makes conductive connection between the input terminal 102 and the output terminal 103 and is fused at the time when an overcurrent flows.

This kind of fuse 101 including the input terminal 102, the output terminal 103 and the fusible part 110 is generally formed by punching a flat plate material made of copper alloy by a press.

Patent Document: JP-A-2008-226743

### SUMMARY OF THE INVENTION

Incidentally, in the case of the fuse 101 formed by press molding, dimensions and a shape of the fusible part cannot be set freely since there is a limit on a decrease in a cross-sectional area of the fusible part 110 due to the restrictions of manufacture.

For example, the whole length of the fusible part 110 may increase since it is necessary to ensure a rated capacity under condition that the cross-sectional area of the fusible part 110 cannot be decreased. As a result, it is necessary to devise arrangement of the fusible part 110, and the whole length is obtained by molding the fusible part 110 in a bent shape in plan view as shown in FIG. 7.

That is, a first linear part 111 of a length L11, a second linear part 112 of a length L12 folded from the distal end of the first linear part 111 and a third linear part 113 of a length L13 folded from the distal end of the second linear part 112 are continuously formed to thereby obtain the fusible part 110 with the whole length L=L11+L12+L13.

However, when the fusible part 110 is formed in the bent shape in this manner by punching of the press, a condition of punching requires unnecessary wasted space SP, and planar occupied space of the fusible part 110 increases, with the result that miniaturization of the fuse may be limited.

Hence, one of objects of the invention is related to solving the problem described above, and is to provide a fuse capable of freely setting dimensions or a shape of a fusible part.

The object of the invention described above is achieved by the following configurations.

(1) A fuse including: a pair of terminals; and a fusible part that is provided between the pair of terminals, makes conductive connection between both of the pair of terminals, and is fused when an overcurrent flows, wherein at least the fusible part is manufactured by a stereoscopic modeling method.

(2) The fuse according to (1), wherein the fusible part is formed in a folded shape with substantially a Z shape in side view.

According to the fuse with the configuration of the above (1), the fusible part is manufactured by the stereoscopic modeling method, with the result that cross-sectional dimensions, lengths, shapes, etc. of the fusible part can be set freely. Consequently, by decreasing the cross-sectional dimensions (width or thickness) of the fusible part, the whole length of the fusible part can be decreased to thereby miniaturize the fusible part and therefore the fuse.

According to the fuse with the configuration of the above (2), even when the whole length of the fusible part becomes long, by configuring the fusible part in three dimensions, the shape in plan view can be decreased to thereby contribute to miniaturization of the fusible part and therefore the fuse. Also, the fusible part has the folded shape, with the result that heat of the fusible part of the lower side rises upwardly by an attitude used and thereby, fusing of the fusible part of the upper side can be facilitated to improve fusing performance.

According to the embodiments of the invention, the fusible part is manufactured by the stereoscopic modeling method, with the result that the cross-sectional dimensions, lengths, shapes, etc. of the fusible part can be set freely, and the fusible part can cope flexibly with a change in capacity.

The invention has briefly been described above. Further, the details of the invention will become more apparent by reading through a mode (hereinafter called an “embodiment”) for carrying out the invention described below with reference to the accompanying drawings.

### BRIEF DESCRIPTION OF THE DRAWINGS

FIGS. 1A to 1C are explanatory views of a fuse of a first embodiment of the invention. FIG. 1A is a perspective view mainly showing a fusible part. FIG. 1B is a plan view of the fusible part. FIG. 1C is a side view of the fusible part.

FIG. 2 is a plan view showing an example of application of the fuse of FIGS. 1A to 1C.

FIGS. 3A and 3B are views showing a modified example of the first embodiment. FIG. 3A is a front view of a fusible part. FIG. 3B is a side view of the fusible part.

FIGS. 4A and 4B are explanatory views of a blade-shaped fuse as a second embodiment of the invention. FIG. 4A is the whole perspective view of the blade-shaped fuse. FIG. 4B is a perspective view showing a configuration of only a fuse body with an insulating housing of the blade-shaped fuse removed.

FIGS. 5A to 5E are explanatory views of variations of the fuse body of FIG. 4B. FIG. 5A is a perspective view showing a state of only a pair of tab terminals with a fusible part removed. FIGS. 5B to 5E are perspective views showing examples of fuse bodies into which different fusible parts are incorporated.

FIG. 6 is a plan view of a related-art fuse.

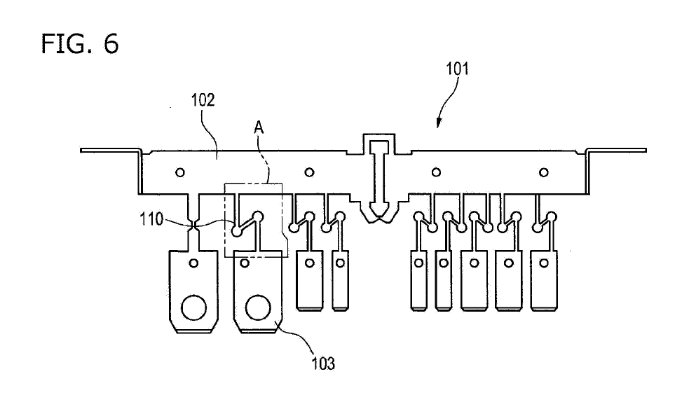

FIG. 7 is an enlarged view of part A of FIG. 6.

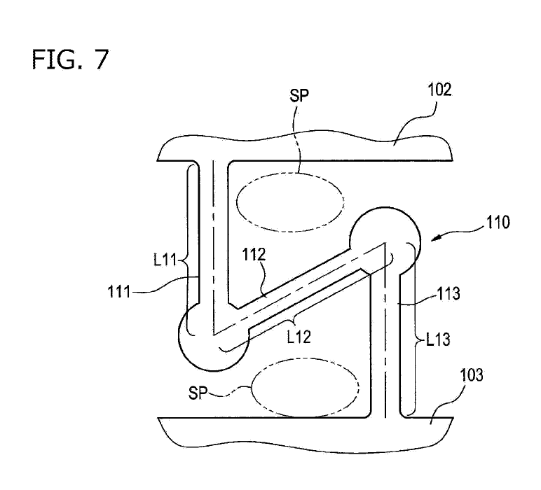

### DETAILED DESCRIPTION OF THE EXEMPLARY EMBODIMENTS

Embodiments of the invention will hereinafter be described with reference to the drawings.

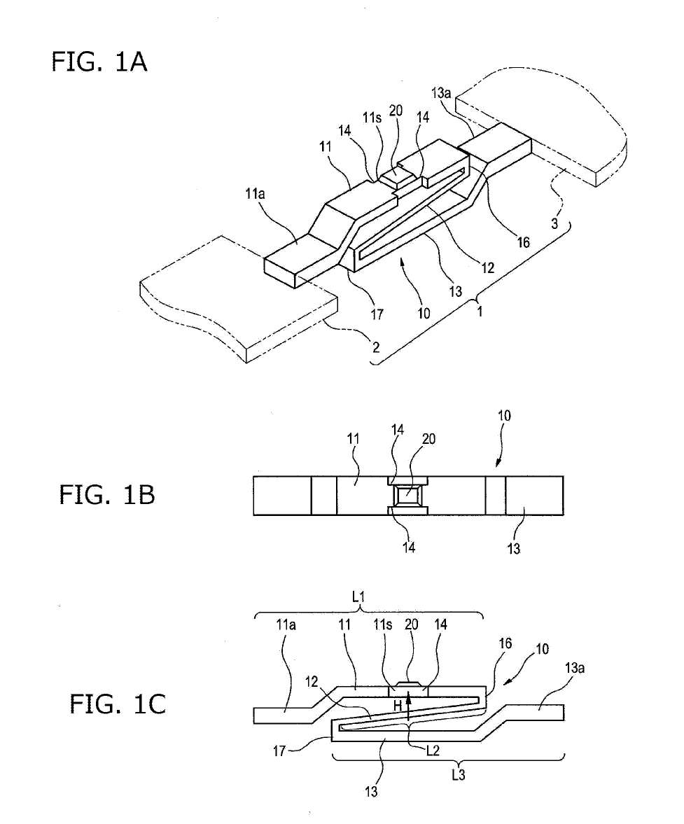

FIGS. 1A to 1C are explanatory views of a fuse of a first embodiment. FIG. 1A is a perspective view mainly showing a fusible part, FIG. 1B is a plan view of the fusible part, and FIG. 1C is a side view of the fusible part.

As shown in FIGS. 1A to 1C, a fuse 1 of this embodiment has a pair of flat plate-shaped terminals 2 and 3 on both ends, and has a fusible part 10, which makes conductive connection between both of the terminals 2 and 3 and is fused at the time when an overcurrent flows, between the pair of these terminals 2 and 3. A predetermined place (a fusing setting part 11s described below) of the fusible part 10 is provided with a low-melting-point metal layer 20.

Here, a metal conductor constructing the terminals 2 and 3 and the fusible part 10 is made of a copper alloy. On the other hand, the low-melting-point metal layer 20 is made of a tin alloy or tin (Sn) with a melting point lower than that of copper (Cu), and is configured to be melted by a rise in temperature by energization and be diffused inside the fusing setting part and form an alloy layer.

The fusible part 10 is formed in a folded shape with substantially a Z shape in side view in which a first strip plate piece 11 of the uppermost side, a second strip plate piece 12 of its lower side and a third strip plate piece 13 of the lowermost side are formed continuously. Concretely, the second strip plate piece 12 continues with the distal end of the first strip plate piece 11 through a bent part 16 bent in a U shape in a thickness direction, and the third strip plate piece 13 continues with the distal end of the second strip plate piece 12 through a bent part 17 bent in a U shape in the thickness direction.

And, the second strip plate piece 12 is positioned just over the third strip plate piece 13 at a short distance, and the first strip plate piece 11 is positioned just over the second strip plate piece 12 at a short distance. Also, the proximal end 11a of the first strip plate piece 11 and the proximal end 13a of the third strip plate piece 13 are set in the same height, and are connected to the terminals 2 and 3, respectively.

An intermediate part of the first strip plate piece 11 of the uppermost side in a length direction is provided with the fusing setting part 11s melted and cut by a rise in temperature by an overcurrent. The fusing setting part 11s is the portion set so as to be instantaneously fused at the time when a large current flows by locally making the cross-sectional area smaller than that of the other portion by putting notches 14 in both side edges in a width direction.

The low-melting-point metal layer 20 has a melting point lower than that of a fusible metal conductor constructing the fusible part 10, and is melted by an overcurrent and is diffused in the fusing setting part 11s to form an alloy layer, and is formed on the fusing setting part 11s (may be formed on any of an upper surface, a lower surface, a side surface and the whole peripheral surface of the fusing setting part 11s). By forming the low-melting-point metal layer 20 in this manner, a wide contact surface is ensured between the fusible part 10 and the low-melting-point metal layer 20, and a current and heat are effectively transferred to the low-melting-point metal layer 20 through this wide contact surface.

Both of the terminals 2 and 3 in elements constructing this fuse 1 are formed by punching a metal flat plate material by a press. On the other hand, the fusible part 10 is formed by a stereoscopic modeling method (three-dimensional modeling method by a so-called 3D printer) rather than press molding. This fusible part 10 is constructed of a powder sintered body made of a copper alloy such as NB105.

Connection between the terminals 2 and 3 and the fusible part 10 can also be made using welding means etc. after the fusible part 10 is manufactured by the stereoscopic modeling method, but the connection is made by the stereoscopic modeling method itself since the stereoscopic modeling method is adopted for manufacture of the fusible part 10 herein. In other words, the terminals 2 and 3 are previously held in modeling space in which the stereoscopic modeling method is performed, and the fusible part 10 is manufactured in the form of integrating the fusible part 10 with the terminals 2 and 3 by the stereoscopic modeling method. Accordingly, a product in which the terminals 2 and 3 are coupled to the fusible part 10 manufactured can be obtained.

Also, in the low-melting-point metal layer 20, a chip-shaped low-melting-point metal can be coupled to the fusible part 10 in a layer state at the same time as manufacture of the fusible part 10 by the stereoscopic modeling method. Also, after manufacture of the fusible part 10, the manufactured fusible part 10 is held in modeling space and then, the low-melting-point metal layer 20 may be manufactured in the form of being integrated with the fusible part 10 by the stereoscopic modeling method. Also, it is contemplated to simultaneously manufacture the low-melting-point metal layer 20 and the fusible part 10 made of different kinds of metals by the stereoscopic modeling method.

The stereoscopic modeling method is a technique for modeling a three-dimensional product shape by slicing three-dimensional shape data of a product into thin layers on a calculator and calculating cross-sectional shape data of each of the sliced layers and sequentially forming thin layers physically by the calculated data and laminating and coupling the thin layers.

The stereoscopic modeling method includes a fused deposition modeling method, an optical modeling method, a powder sintering method, an ink-jet method, a projection method, an ink-jet powder lamination method, etc., and since a material is a metal herein, the powder sintering method or the ink-jet powder lamination method is effective.

For example, the powder sintering method performs modeling in the following order.

(1) First, material powder is thinly laid on a bed for modeling.

(2) Next, a cross-sectional shape of the lowermost layer of cross-sectional shapes is drawn by, for example, a laser, an electron beam or ultraviolet rays, and powder of the drawn portion is sintered.

(3) After a cross section of the lowermost layer is sintered, the bed is downwardly moved by height equal to a slice interval, and the material powder is laid on the bed in thinness equal to the slice interval.

(4) Then, a cross-sectional shape of a layer upper than the previously formed cross section by one is again drawn by a laser, and powder of the drawn portion is sintered.

(5) A three-dimensional object is modeled by repeating the above steps.

Also, in the ink-jet powder lamination method, material powder is discharged just like an ink-jet printer, and, for example, a laser, ultraviolet rays or heat is applied to the material powder to sinter the material powder, and while sequentially repeating sintering and lamination of thin layers, an integral three-dimensional object is modeled.

Since the fusible part 10 is manufactured by the stereoscopic modeling method in this manner, cross-sectional dimensions, lengths, shapes, etc. of the fusible part 10 can beset freely. For example, thickness, width, length or shape can be set freely. Consequently, by decreasing the cross-sectional dimensions (width or thickness) of the fusible part 10, the whole length L (L=length L1 of the first strip plate piece 11+length L2 of the second strip plate piece 12+length L3 of the third strip plate piece 13) of the fusible part 10 can be decreased to thereby miniaturize the fusible part 10 and therefore the fuse 1.

Also, even when the whole length of the fusible part 10 becomes long, by configuring the fusible part 10 in three dimensions like the embodiment, the shape in plan view can be decreased to thereby contribute to miniaturization of the fusible part 10 and therefore the fuse 1. Particularly in the case of the fuse 1 of the embodiment, the fusible part 10 has the folded shape, with the result that heat of the fusible part (second and third strip plate pieces 12, 13) of the lower side rises upwardly as shown by arrow H in FIG. 1C according to an attitude used and thereby, fusing of the fusing setting part 11s of the fusible part (first strip plate piece 11) of the upper side can be facilitated to improve fusing performance.

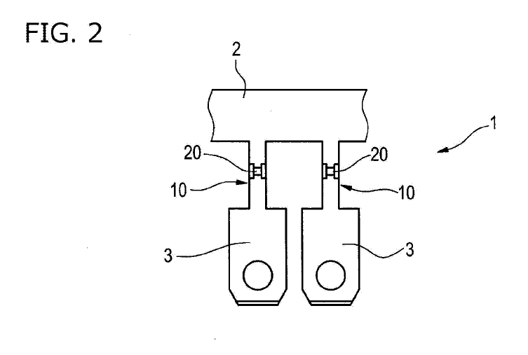

The fuse 1 configured in this manner can be used in a part of the linked fuse (fusible link) as shown in FIG. 2.

In addition, in the embodiment, the case of manufacturing only the fusible part 10 by the stereoscopic modeling method is shown, but the fuse 1 including the terminals 2 and 3 may be manufactured by the stereoscopic modeling method. Also, the low-melting-point metal layer 20 with a different material may be manufactured by the stereoscopic modeling method.

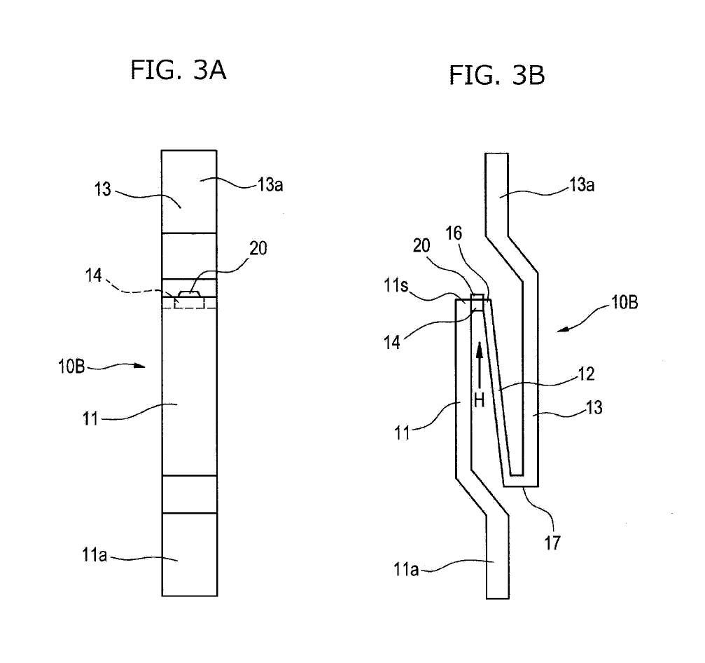

Also, the embodiment assumes and describes the case of arranging the first strip plate piece 11, the second strip plate piece 12 and the third strip plate piece 13 of the fuse 1 in a vertical direction, that is, the case of arranging the fuse 1 in a horizontal attitude, but the case of using the fuse 1 in an erected attitude can also be considered as shown in FIGS. 3A and 3B. In such a case, when the fusing setting part 11s is positioned in the center of the first strip plate piece 11 in a longitudinal direction as shown in FIG. 1, the fusing setting part 11s is not present over the second strip plate piece 12 and the third strip plate piece 13, with the result that the fusing setting part 11s is insusceptible to heat generated from the second strip plate piece 12 and the third strip plate piece 13.

Hence, in such a case of use in the erected attitude, like a fusible part 10B of a modified example shown in FIGS. 3A and 3B, the fusing setting part 11s is positioned in the upper end side in an attitude in use, for example, is arranged in the bent part 16. Consequently, heat generated from the first strip plate piece 11, the second strip plate piece 12 and the third strip plate piece 13 rises toward the fusing setting part 11s as shown by arrow H, with the result that fusing of the fusing setting part 11s can be facilitated. Also in this case, the fusing setting part 11s is provided with the low-melting-point metal layer 20.

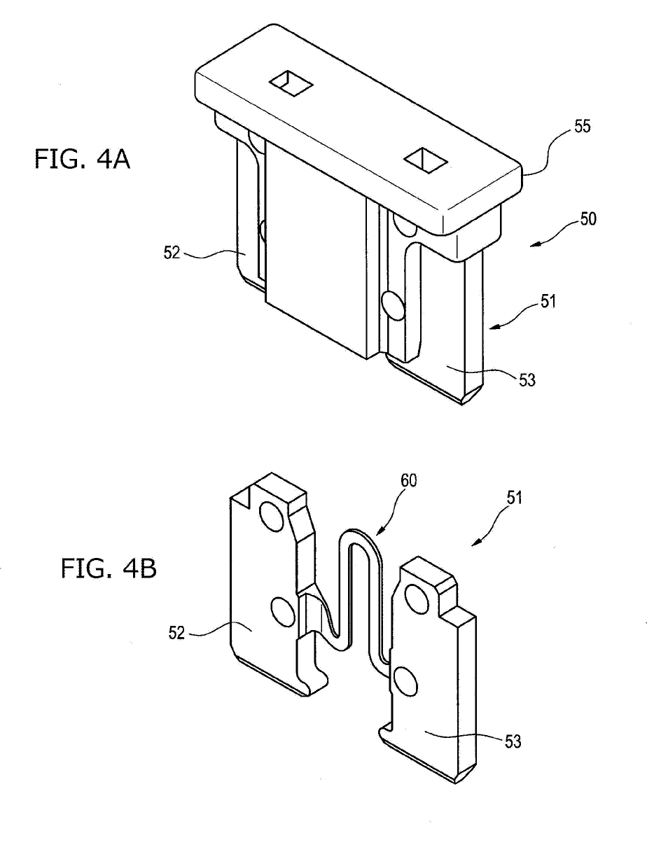

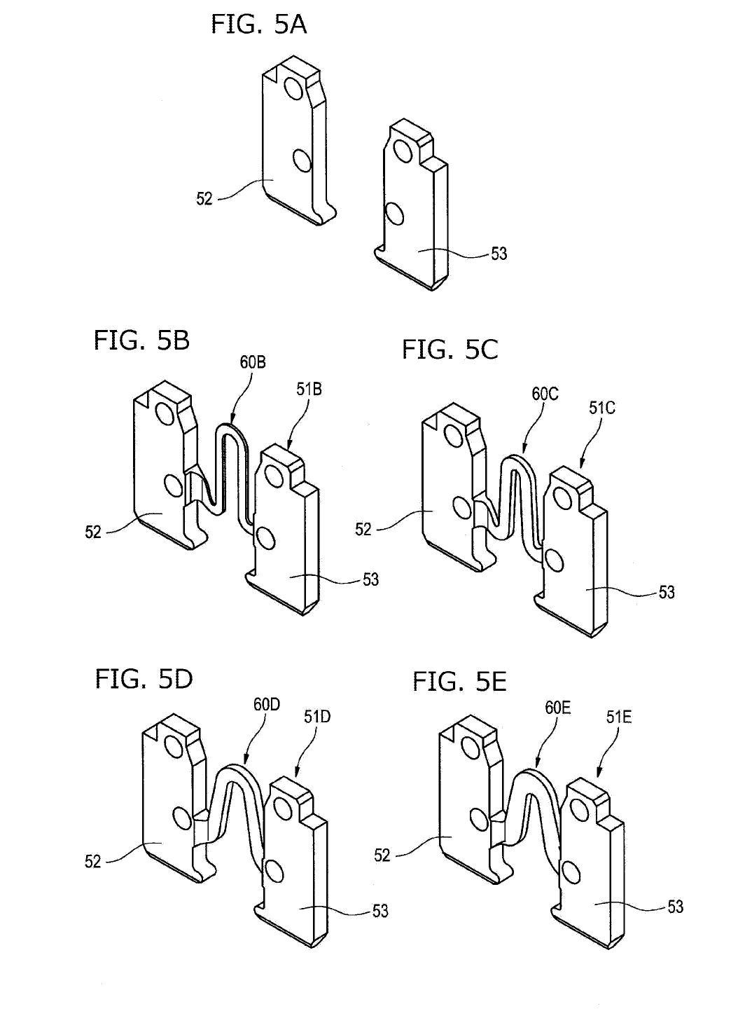

FIGS. 4A and 4B are explanatory views of a blade-shaped fuse as a second embodiment of the invention. FIG. 4A is the whole perspective view of the blade-shaped fuse, and FIG. 4B is a perspective view showing a configuration of only a fuse body with an insulating housing of the blade-shaped fuse removed. FIGS. 5A to 5E are explanatory views of variations of the fuse body of FIG. 4B. FIG. 5A is a perspective view showing a state of only a pair of tab terminals with a fusible part removed, and FIGS. 5B to 5E are perspective views showing examples of fuse bodies into which different fusible parts are incorporated.

As shown in FIG. 4A, this blade-shaped fuse 50 is formed by setting a fuse body 51 (corresponding to a fuse of claim 1) inside a mold and insert-molding a resin housing 55. The fuse body 51 has a pair of tab terminals 52 and 53 on both ends, and has a fusible part 60, which makes conductive connection between both of the tab terminals 52 and 53 and is fused at the time when an overcurrent flows, between the pair of these tab terminals 52 and 53 as shown in FIG. 4B. The fusible part 60 is formed in a curved shape with an inverted U shape, and both ends of the fusible part 60 are joined to inside edges of the tab terminals 52 and 53.

Both of the tab terminals 52 and 53 in elements constructing this fuse body 51 are formed by punching a flat plate material made of a copper alloy by a press as shown in FIG. 5A. On the other hand, the fusible part 60 is formed by a stereoscopic modeling method (three-dimensional modeling method by the so-called 3D printer) rather than press molding. This fusible part 60 is constructed of a powder sintered body made of a copper alloy such as NB105.

Connection between the tab terminals 52 and 53 and the fusible part 60 can also be made using welding means etc. after the fusible part 60 is manufactured by the stereoscopic modeling method, but the connection is made by the stereoscopic modeling method itself since the stereoscopic modeling method is adopted for manufacture of the fusible part 60 herein. In other words, the tab terminals 52 and 53 are previously held in modeling space in which the stereoscopic modeling method is performed, and the fusible part 60 is manufactured in the form of integrating the fusible part 60 with the tab terminals 52 and 53 by the stereoscopic modeling method. Accordingly, a product (fuse body 51) in which the tab terminals 52 and 53 are coupled to the fusible part 60 manufactured can be obtained.

Since the fusible part 60 is manufactured by the stereoscopic modeling method in this manner, the cross-sectional dimensions, lengths, shapes, etc. of the fusible part 60 can be set freely. For example, like fusible parts 60B to 60E shown in FIGS. 5B to 5E, the thickness, width, length or shape can be set freely, and fuse bodies 51B to 51E with different fusing capacities can be manufactured easily. Also, by decreasing the cross-sectional dimensions (width or thickness) of the fusible part 60, the whole length of the fusible part 60 can be decreased to thereby miniaturize the fusible part 60 and also miniaturize the fuse 50.

In addition, the invention is not limited to the embodiments described above, and modifications, improvements, etc. can be made properly. Moreover, as long as the invention can be achieved, materials, shapes, dimensions, the number of components, arrangement places, etc. of each of the components in the embodiments described above are freely selected and are not limited.

Here, features of the embodiments of the fuse according to the invention described above are briefly summarized and listed in the following [1] and [2], respectively.

[1] Fuses (1, 51, 51B to 51E) including fusible parts (10, 60, 60B to 60E) between a pair of terminals (2, 3, 52, 53), the fusible part which makes conductive connection between both of the terminals (2, 3, 52, 53) and is fused at the time when an overcurrent flows, wherein at least the fusible parts (10, 60, 60B to 60E) are manufactured by a stereoscopic modeling method.

[2] A fuse (1) as described in the above [1], wherein the fusible part (10) is formed in a folded shape with substantially a Z shape in side view.

What is claimed is:

1. A fuse comprising:
a pair of terminals; and
a fusible part that is provided between the pair of terminals, makes conductive connection between both of the pair of terminals, and is fused when an overcurrent flows, wherein
at least the fusible part is manufactured by a stereoscopic modeling method.

2. The fuse according to claim 1, wherein the fusible part is formed in a folded shape with substantially a Z shape in side view.
